(19) United States
(12) Patent Application Publication
(10) Pub. No.: US 2024/0078894 A1
(43) Pub. Date: Mar. 7, 2024

(54) SMOKE ALARM TAMPER PROTECTION DEVICE

(71) Applicant: FireAvert, LLC, Springville, UT (US)

(72) Inventors: Peter Thorpe, Springville, UT (US); Larsen Alma Webb, Springville, UT (US); Dallin Woodbrey, Springville, UT (US)

(21) Appl. No.: 18/462,347

(22) Filed: Sep. 6, 2023

Related U.S. Application Data
(60) Provisional application No. 63/404,032, filed on Sep. 6, 2022.

(51) Int. Cl. G08B 29/04

(52) U.S. Cl. CPC G08B 29/046; G08B 29/043

(57) ABSTRACT

Embodiments described herein are directed to systems and apparatuses that deter tampering with smoke alarms. In one scenario, such a system may include a tamper detection component that is affixed to a smoke alarm, a support structure that includes a locking mechanism and an extended portion that aligns with an extended cavity of an interlocking cover portion, a sensor positioned within a specified maximum distance from the tamper detection component, an interlocking cover portion that includes an aperture for the sensor and that locks into place over the support structure using the locking mechanism, a controller configured to interpret sensor data received from the sensor, and a transmitter configured to transmit notification data to various specified entities based on the interpreted sensor data. Other corresponding apparatuses and devices are also described.

### CROSS-REFERENCE TO RELATED APPLICATIONS

This application claims priority to and the benefit of U.S. Provisional Patent App. No. 63/404,032, entitled “Smoke Alarm Tamper Protection Device,” filed on Sep. 6, 2022, which application is incorporated by reference herein in its entirety.

### BACKGROUND

Homes, apartments, and other buildings are, unfortunately, destroyed by fire each year. Many of these buildings have smoke alarms installed that, when working properly, would allow the inhabitants to escape before suffering bodily harm. Many times, however, residents tamper with their smoke alarms. Such tampering may include taking the batteries out of the smoke alarm, disconnecting the alarm from wall power, covering the alarm with a bag or similar covering, or removing the smoke alarm entirely. As such, the owner of a house, apartment complex, or building may think that the building is protected when, in fact, it is not.

### BRIEF SUMMARY

Embodiments described herein are directed to systems and apparatuses that deter tampering with smoke alarms. In one embodiment, a system may include a tamper detection component that is affixed to a smoke alarm. The system may further include a support structure that includes a locking mechanism, as well as an extended portion that aligns with an extended cavity of an interlocking cover portion. Furthermore, the system may include a sensor positioned within a specified maximum distance from the tamper detection component, an interlocking cover portion that includes an aperture for the sensor and that locks into place over the support structure using the locking mechanism, a controller configured to interpret sensor data received from the sensor, and a transmitter configured to transmit notification data to various specified entities based on the interpreted sensor data.

In some embodiments, the locking mechanism may be a geared locking mechanism. In some cases, the tamper detection component may be a magnet. In such cases, the sensor may be a magnetometer configured to detect a magnetic field's direction, strength, or relative change. In some cases, the support structure may be secured to a wall or ceiling and is positioned substantially adjacent to the smoke detector.

In some examples, the interlocking cover portion may be secured in place over the support structure via a magnet, a threaded connection, a screw, a clasp, or a securing pin. In some cases, the sensor may be a microwave motion detector, a passive infrared (PIR) sensor, or a photodiode configured to sense light from a light emitting diode.

In some embodiments, the tamper component may be affixed to an exterior portion of the smoke alarm. In some cases, the tamper component may be affixed to an interior portion of the smoke alarm or may be integrated into the smoke alarm. In some examples, the sensor may be mounted internally within the smoke alarm and may be positioned within the specified maximum distance from the tamper detection component. In some cases, the interlocking cover portion may include one or more molded indicators indicating how to align the sensor with the tamper detection component.

In addition to the system described above, an apparatus may be provided that includes: a tamper detection component that is affixed to at least a portion of a smoke alarm, a support structure that includes a locking mechanism and an extended portion that aligns with an extended cavity of an interlocking cover portion, a sensor positioned within a specified maximum distance from the tamper detection component, an interlocking cover portion that includes an aperture for the sensor and that locks into place over the support structure using the locking mechanism, a controller configured to interpret sensor data received from the sensor, and a transmitter configured to transmit notification data to one or more specified entities based on the interpreted sensor data.

In some cases, interpreting sensor data by the controller may include detecting at least a specified minimum amount of change in a monitored characteristic. In some examples, detecting at least a specified minimum amount of change in the monitored characteristic may include detecting a different amount of change in the monitored characteristic for each of a plurality of different sensor types. In other cases, detecting at least a specified minimum amount of change in the monitored characteristic may include detecting a different amount of change in the monitored characteristic for each of a plurality of different locations in which the apparatus is mounted. In still other cases, detecting at least a specified minimum amount of change in the monitored characteristic may include detecting a different amount of change in the monitored characteristic for each of a plurality of different users that implement the apparatus.

In some embodiments, the tamper component may be affixed to an exterior portion of the smoke alarm. In some cases, the tamper component may be affixed to an interior portion of the smoke alarm. In some examples, the sensor may be mounted internally within the smoke alarm and may be positioned within the specified maximum distance from the tamper detection component. In some cases, the tamper detection component may be a magnet, and the sensor may be a magnetometer configured to detect a magnetic field's direction, strength, or relative change.

A corresponding tamper detection device may also be provided, which may include: a tamper detection component that is affixed to at least a portion of a smoke alarm, a support structure that includes a locking mechanism and an extended portion that aligns with an extended cavity of an interlocking cover portion, a sensor positioned within a specified maximum distance from the tamper detection component, the interlocking cover portion that includes an aperture for the sensor and that locks into place over the support structure using the locking mechanism, a controller configured to interpret sensor data received from the sensor, and a transmitter configured to transmit notification data to one or more specified entities based on the interpreted sensor data.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a smoke alarm and a tamper detection device mounted next to the smoke alarm.

FIG. 2 illustrates an embodiment of a tamper detection device that may be mounted near a smoke alarm.

FIG. 3 illustrates an exploded view of an embodiment of a tamper detection device.

FIG. 4 illustrates an embodiment in which a magnetometer is used as a sensor in a tamper detection device.

FIG. 5 illustrates an embodiment in which an alternative sensor is used in a tamper detection device.

### DETAILED DESCRIPTION

The present disclosure is generally directed to systems, apparatuses, and devices for preventing tampering with smoke alarms. As noted above, many buildings and homes experience fires that burn longer than necessary due to the actions of people, including removing or disabling smoke alarms. When working properly, smoke alarms will detect smoke and will sound an alarm so that those in the building can escape, ideally without experiencing any bodily harm. However, if users remove the smoke alarm's batteries, or disconnect the alarm from power, or cover the smoke alarm, or remove it entirely, a fire in that building may go undetected and may burn much longer than it would have if the fire had been promptly detected.

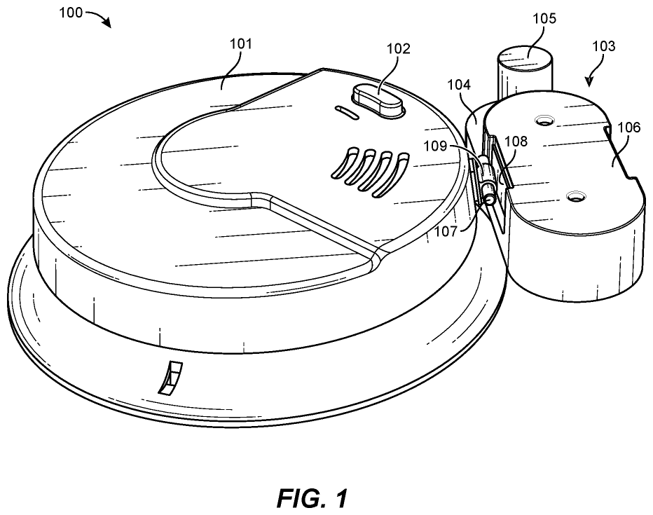

The embodiments described herein, as generally shown in FIGS. 1-5, provide a tamper prevention system that includes multiple component pieces. These pieces, when assembled and implemented together, may prevent or at least deter users from tampering with a smoke alarm.

For example, in some embodiments, as generally illustrated in embodiment 100 of FIG. 1, these systems may include a separate tamper detection component 107 that is affixed to a smoke alarm 101. This tamper detection component 107 may be attached to or affixed to some part of the smoke alarm 101. In some cases, for instance, the tamper detection component 107 may be positioned near the smoke alarm's battery access point.

The tamper detection component 107 may operate in conjunction with a sensor 108 to detect whether the smoke alarm has been moved, rotated, opened, covered, or otherwise tampered with. The tamper detection component may be a magnet, a light emitting diode (LED) (e.g., an infrared LED), a reflective device, or other component that may assist a sensor in detecting movement of or tampering with the smoke alarm.

In FIG. 1, for instance, the tamper detection component 107 may be a magnet, and the sensor 108 of the tamper protection system 103 may be a magnetometer. The magnetometer may be configured to detect a magnetic field put off by the magnet attached to the smoke alarm. The magnetometer may be configured to check for the presence of the magnetic field, may detect changes in the magnetic field's direction, changes in the magnetic field's strength, or relative changes in the magnetic field. These types of changes may indicate that the smoke alarm has been removed, covered, or otherwise tampered with. Other sensors, as noted below, may detect other changes in the smoke alarm 101 or the smoke alarm's environment.

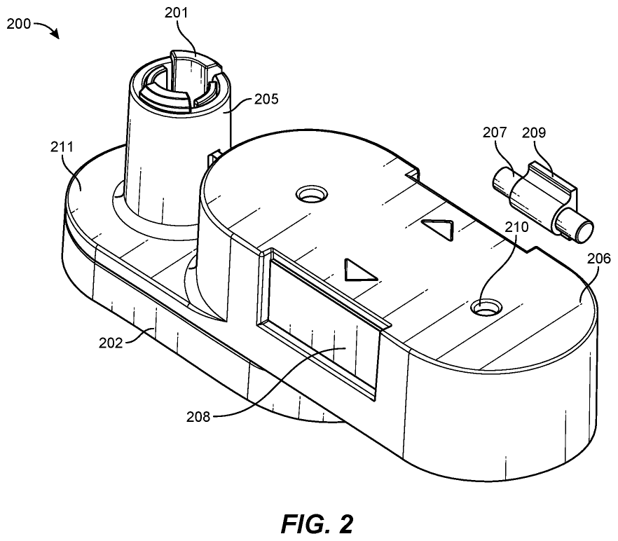

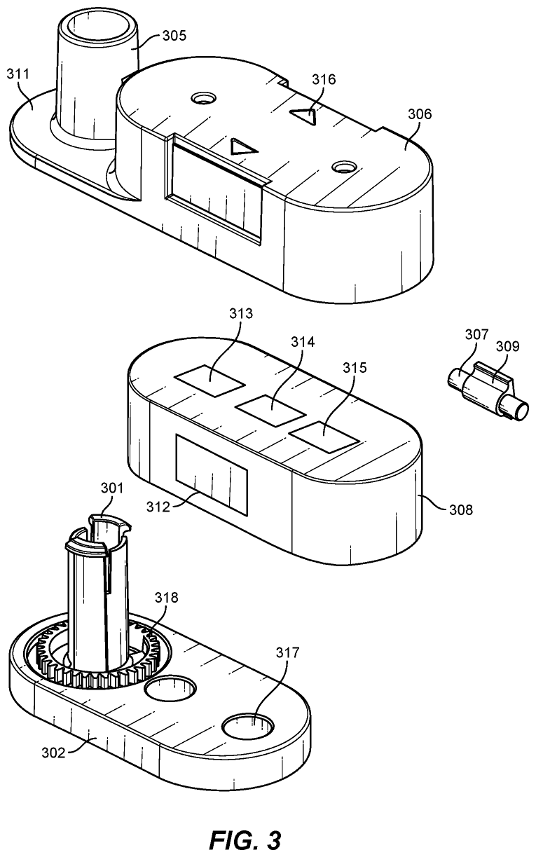

The tamper prevention system 103 may further include a support structure that has a locking mechanism and an extended portion 105 that aligns with an extended cavity of an interlocking cover portion 106. As will be further shown in FIGS. 2-3, the support structure 104 may include apertures that allow the support structure to be mounted to a wall, to a ceiling, or to other locations. The support structure 104 may also include an extended portion 105 that protrudes outwards and may be inserted into an interlocking cover. The extended portion 105 may be long enough to prevent users from easily removing the interlocking cover portion from the support structure.

For example, once the cover portion 106 is in position over the extended portion, it may be highly difficult to remove the cover portion from the support structure. Because the cover portion 106 houses the movement/tampering sensor 108, the cover portion cannot be removed without tripping the sensor to indicate that movement has occurred and that the smoke alarm has been tampered with. In this manner, the tamper prevention system may ensure that users have not altered or diminished the functionality of the smoke alarm 101.

The tamper prevention system 103 may be mounted substantially adjacent to the smoke alarm 101, as shown in FIG. 1. Such mounting may be used when the sensor is a magnetometer, for instance, which is detecting the magnetic field emitted by a magnet 107 that is attached to the smoke alarm via a coupler 109. The tamper prevention system 103 may be similarly closely mounted to the smoke alarm 101 in cases where a passive infrared or other short-range sensor is used. In other cases, the tamper prevention system 103 may be mounted further away from the smoke alarm 101.

For instance, in cases where the tamper detection device 107 is a photodiode configured to sense light from an LED, that photodiode may be positioned further away from the smoke alarm while still allowing the tamper prevention system 103 to function as intended. If a user hears an alarm and merely hits the reset button 102, the alarm will not be tripped. Whereas, if the user attempts to cover or remove the smoke alarm 101, the connection between the tamper detection component 107 and the sensor 108 will be broken and corrective actions (e.g., sending notifications) will be taken.

FIG. 2 illustrates an embodiment of a tamper prevention system 200 that includes multiple different component parts. These component parts may be different than or the same as those shown in FIG. 1. The tamper prevention system 200 of FIG. 2 may include a tamper detection component 207 that may be affixed to a smoke alarm (e.g., 101 of FIG. 1). The tamper detection component, in this case, is a magnet that may be positioned near or within range of the sensor 208. The sensor 208 may be configured to detect the presence of the magnet 207, as well as any changes that may occur in relation to the magnet, including changes in polarity, field strength, or other characteristics.

In some cases, these characteristics may each have a minimum threshold associated with them, such that each characteristic (e.g., polarity, field strength, relative change, etc.) will trigger a notification at a different level. Once that threshold level for the associated characteristic has been reached, processors and transmitters within the tamper prevention system 200 may be used to generate and transmit a notification to specific entities.

The tamper prevention system 200 may also include a support structure 202. The support structure 202 may include a locking mechanism (not shown in FIG. 2), as well as an extended portion 205 that aligns with an extended cavity of an interlocking cover portion 211. The locking mechanism 201 may be a geared locking mechanism that allows the tamper prevention system 200 to be positioned and locked into place. In some cases, for example, the extended portion 205 of the support structure 202 may be positioned over the support structure and may be rotated along the gears until the sensor 208 is in proper position relative to the tamper detection component 207. The gears may allow the interlocking cover portion 211 to be moved and positioned in a fine-grained manner, allowing precise alignment between the sensor 208 and the tamper detection component 207.

In some cases, the sensor 208 may be positioned within a specified maximum distance from the tamper detection component 207. As noted above, this specified maximum distance may be different for different types of sensors. In some cases, the tamper prevention system 200 may implement multiple different sensors and detection components simultaneously or in redundant operation. In some cases, the sensor(s) 208 may include substantially any type of sensor that is configured to detect movement, including movement of the smoke alarm itself and/or movement of the tamper detection component 207 that is affixed to the smoke alarm.

Each different sensor (in cases where multiple sensors are used) may be positioned within that sensor's maximum specified distance from the tamper detection component 207. This maximum distance may depend on which type of sensor is used and/or which type of smoke alarm is used. Moreover, if multiple sensors are in use, the use of one type of sensor may cause the maximum specified distance to change for the other sensor(s). In some embodiments, as noted above, the sensor 208 may be a magnetometer. The magnetometer may detect the strength of a magnetic field emanated from a magnet that is embedded in or is otherwise part of the tamper detection component. If the magnetic field changes beyond a specified amount, the smoke alarm will be deemed to have been tampered with and will send a notification or take other action.

The interlocking cover portion 211 of the tamper prevention system 200 may include an elongated section 206 that has an aperture for the sensor 208. The interlocking cover portion 211 may lock into place over the support structure 202 using the locking mechanism 201. The locking mechanism 201 may include clips, springs, levers, or other elements that hold the interlocking cover portion 211 into place over the support structure 202. The interlocking cover portion 211 may also include screw holes for mounting. The support structure 202 may be separately mounted using screws, tape (e.g., double-sided tape), clips, or other suitable fasteners.

Still further, the tamper prevention system 200 may include a processor and/or controller that is configured to interpret sensor data received from the sensor 208 and take one or more specified actions based on that sensor data. For instance, the processor or controller may communicate with a transmitter to transmit notification data to various entities based on the interpreted sensor data. If, for example, the processor interprets the sensor data to have surpassed one of the established maximum threshold values for the sensor 208 and tamper detection component 207, the processor may prepare and send emails, text notifications, application-based (i.e., “app-based”) communications, or other notifications to a list of predetermined recipients.

FIG. 3 illustrates an embodiment of an exploded view of the tamper prevention system 200 of FIG. 2. The tamper prevention system shown in FIG. 3 may include a support structure 302 with an extended portion 301 that prevents users from lifting the interlocking cover 311 from off of the support structure 302 without tripping the tamper sensor. In some cases, the support structure 302 includes a locking mechanism 318 with gears that allow the interlocking cover 311 to be ratcheted or adjusted into place immediately next to the smoke alarm. The gears may also function to lock the interlocking cover 311 into place so that it cannot be adjusted away from its designated (installed) position without tripping the tamper sensor. The support structure 302 may also include screw holes 317 or other means of affixing the support structure 302 to a ceiling, to a wall, or to another structure.

In some cases, the extended portion 301 of the support structure 302 may itself include an extended, dual-sided clip with apertures that allow for flexibility of the clip elements. The clip may fixedly attach to the interlocking cover 311, ensuring that the cover (which houses the sensor 308) stays in position next to the tamper detection component 307. In some embodiments, the sensor may be part of a computing block 312 that includes multiple different electronic components. For instance, the computing block 312 may include a sensor 308 (e.g., a magnetometer, a photodiode, a passive infrared sensor, an accelerometer, a gyroscope, an IMU, a Hall effect sensor, or other type of sensor), a processor or controller 313, system memory 314, a transmitter 315 or transceiver configured to communicate with other computing systems or wireless networks (e.g., the internet), and/or other electronic components.

The tamper detection system of FIG. 3 may also include an interlocking cover portion 311 that includes an elongated cavity 305 that is positioned over the elongated portion 305 of the support structure 302. The interlocking cover portion 311 may include an aperture for the sensor 308 and may lock into place over the support structure 302 using the locking mechanism. The computing block 312 may be housed within the interlocking cover portion 311 and may be positioned within the specified maximum distance from the tamper detection component 307, which is mounted to the smoke alarm via mounting component 309 or is incorporated into the smoke alarm. In some cases, the extended portion 306 of the interlocking cover portion 311 includes arrows or other indicators 316 indicating on which side the sensor 308 is positioned or is to be positioned during installation.

The sensor 308 may be oriented differently or may be positioned further from or closer to the smoke alarm, depending on which type of tamper sensor is used. In some cases, the sensor 308 may be a microwave motion detector, a passive infrared (PIR) sensor, a photodiode configured to sense light from an LED (e.g., used in place of the magnet 307), an accelerometer, gyroscope, or inertial motion unit (IMU) configured to detect motion, a heat sensor configured to detect a temperature change within the vicinity of the smoke alarm, a spring switch that is configured to detect when a spring has become unsprung (e.g., due to tampering), or other type of sensor that may indicate that a smoke alarm has been moved, covered, or removed entirely.

When movement of the interlocking cover portion 311 or movement of the tamper detection component 307 or movement of the smoke alarm itself is detected, the processor 313 of the tamper detection system may generate a notification and send the notification (e.g., using transmitter 315) to various specified parties. Additionally or alternatively, the tamper detection system may sound an audible alarm (e.g., a beeping sound) that may alert nearby users that the alarm has been tampered with. In some cases, this alarm may be a unique sound that is different from the sound of the smoke alarm. Moreover, at least in some cases, the smoke alarm or a smoke alarm accessory may detect the audible alarm of the tamper prevention system and may issue its own notifications to other parties or trigger its own alarms.

As noted above, the interlocking cover portion 311 may include one or more apertures for the sensor(s). These apertures may be larger or smaller, or may be formed in different shapes depending on which type of sensor is used. The interlocking cover portion may lock into place over the support structure using a locking mechanism. This locking mechanism may include substantially any type of locking mechanism including a magnet, a threaded connection, a screw, a clasp, a securing pin, or similar mechanism. Once placed over the elongated portion 301 of the support structure 302, the (geared) locking mechanism 316 may allow the tamper prevention system to be rotated and locked into place immediately next to the smoke alarm. Then, if the sensor 308 detects any change in signal or any movement away from the tamper detection component 307, the system may generate and send a notification and/or sound a unique alarm that is different from a traditional smoke alarm sound.

In some embodiments, a cage or meshed outer enclosure may be placed around the smoke alarm. This cage may include a mesh or perforated cover, and may cover some or all of the smoke detector. The perforations may allow smoke to still enter the smoke alarm, but if the cage is removed or is twisted or shifted relative to the smoke alarm, the system may trigger a tamper notification, including potentially sounding an alarm and/or notifying specified parties. Thus, instead of being a component or device that is installed next to a smoke alarm, in this embodiment, the tamper detection system is formed as a cage or meshed outer enclosure that locks into place and includes a sensor positioned within the maximum specified distance from the smoke alarm.

In addition to the support structure locking into place, the interlocking cover portion 311 may also lock into place over the support structure 302. The interlocking cover portion 311 may have a corresponding locking mechanism in the elongated portion 301. As such, when the cover is locked into place, the cover cannot be moved without tripping the movement sensor. In such cases, the support structure may be fixedly mounted immediately next to the smoke alarm. The support structure 302 may be designed to be high enough or thick enough that, when the cover is locked into place, the support structure fits over any protruding lip of the smoke alarm. Once in place, the locking mechanism 301 may prevent the cover from being removed away from the smoke alarm.

In some cases, the tamper prevention system may be configured to notify specific parties (e.g., property managers) when a smoke alarm has not been checked for a specified period of time. For example, if a homeowner or apartment manager installs a battery in a smoke alarm that lasts three years, that person may forget to change the battery. The tamper prevention system may be configured to determine that nothing has tampered with the smoke detector in (e.g., three) years and could then send out a notification as a reminder to replace the battery. Other reminders or actions may also be taken on the basis of a lack of tampering for a specified period of time.

This notification may be generated by a controller or processor 313 that is part of (or is communicatively linked to) the tamper prevention system. The controller may be configured to interpret sensor data received from the sensor and, if a significant change has occurred (indicating that tampering has occurred), the controller may generate a notification indicating the type of change that occurred, the current location of the tamper prevention system (e.g., using GPS signals), the current time, an indication of whether the smoke alarm has been triggered, or other information.

The tamper prevention system may also have a transmitter that may be configured to transmit the notification data to various specified entities including the building's owner, insurance companies, apartment complex managers, etc. Accordingly, based on changes in sensor data, the system described herein may determine that a smoke alarm has been modified or changed, and may notify interested parties of these changes. Those parties may then take action to speak to the residents or to go into the dwelling and ensure that the smoke alarm is working or is brought back into working condition.

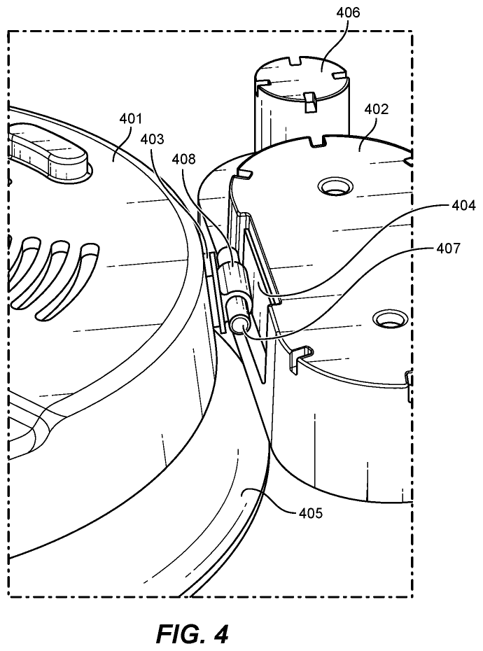

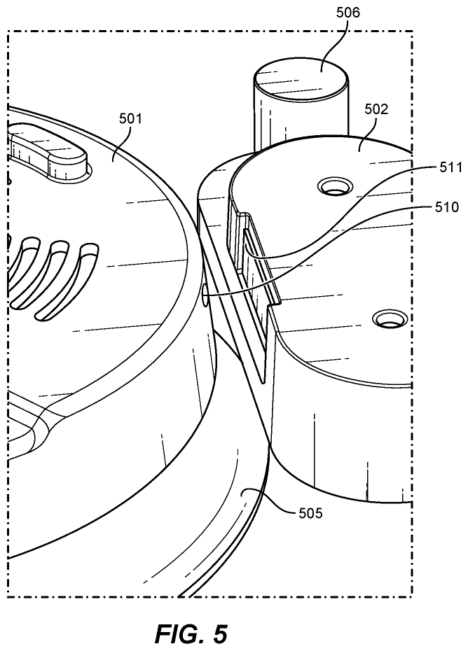

FIGS. 4 and 5 illustrate embodiments illustrate close-up views of a smoke alarm being aligned with a tamper detection device. For instance, in FIG. 4, a smoke alarm 401 is aligned with tamper detection device 402. The smoke alarm 401 may include an aperture that allows a positioning element 408 to be attached thereto. In some cases, the aperture may allow access to the smoke alarm's battery so that the user can change the battery out. In some cases, the positioning element 402 may be glued, taped, screwed, or otherwise fastened to the exterior of the smoke alarm 401. In other cases, the positioning element 402 may be molded into or may be fastened to an interior portion of the smoke alarm 401.

The positioning element 408 may secure or hold a tamper detection component 407. In the embodiment shown in FIG. 4, the tamper detection component 407 may be a magnet, and the sensor 404 may be a magnetometer. In other cases, the tamper detection component 407 may be a passive IR source, or an LED, or a motion sensor, or other type of sensor. This sensor may detect changes in the state of the tamper detection device, including changes in detected IR emissions, changes in LED emissions, changes in motion or position, changes in magnetic field strength, etc.

The sensor may be housed in a computing block (not shown) that includes one or more processors to process or interpret the sensor data and determine that a change has occurred. The computing block may be held in place on the support structure by an interlocking cover component that rests over the computing block and over an extended portion 406 of the support structure. The support structure itself may rest next to or near the base 405 of the smoke alarm and, in some cases, may overlap at least a portion of the base 405.

In FIG. 5, a different type of sensor is shown. This sensor 504 may be a photodiode configured to detect light emitted by an LED 503. In this embodiment, the smoke alarm 501 may include an aperture sized for an LED (and/or other sensors). That LED light shines toward the tamper detection device 502. The photodiode 504 detects changes in light intensity or an absence of emitted light. This, then is interpreted by the processor and, if the change is sufficient, the processor generates and sends a notification to specific entities.

In some cases, such as implementations where an LED and photodiode are used, the tamper detection device may be integrated into an interior portion of the smoke alarm. In such embodiments, the sensor may be mounted internally within the smoke alarm and may be positioned within a specified maximum distance from the tamper detection component, which is also internal to the smoke alarm. In such cases, the computing block, the sensor(s), and the emitting nodes (e.g., the LED, magnet, passive IR emitter, etc.) are internal to the smoke alarm. In this internal-only embodiment, the maximum distance may be maintained for each different type of sensor used. Once a connection has been established between the tamper detection component and the sensor, if sufficient changes occur, the processor will generate and send a notification, sound an alarm, or take other action.

In cases where the tamper detection device is integrated into an interior portion of a smoke alarm, that smoke alarm may be manufactured and sold in a variety of ways. For instance, such an integrated smoke alarm may be manufactured and sold as a custom smoke alarm that includes an integrated tamper detection device. As noted above, the sensors, the emitting diodes, the computing block, and other components of the tamper detection device may be integrated within and may be internal to the custom smoke alarm. Other elements of the smoke alarm, including the smoke detection device, the alarm itself, or other components may also be manufactured specifically for the custom, integrated smoke alarm. Once manufacture, the custom, integrated smoke alarm may be sold as a packaged unit. When installed, the internal tamper detection device may detect any tampering with the smoke alarm, and may send notifications or sound an alarm, or take other action as described above.

In other cases where the tamper detection device is integrated into an interior portion of a smoke alarm, that smoke alarm may be manufactured as an original equipment manufacturer (OEM) smoke alarm with one or more custom components added thereto during the manufacturing process. In such cases, the tamper sensing technology described herein, including the sensors, emitting diodes, magnets, computing block, transceiver, and other components may be incorporated into the OEM smoke alarm after the OEM smoke alarm has been produced. As such, these components may be installed into an existing OEM smoke alarm, thereby making that OEM alarm tamper-proof or at least tamper resistant. This modified OEM smoke alarm may be sold as a packaged unit that includes traditional smoke alarm elements, including a smoke detector and an audible alarm, along with the added tamper prevention components described herein. Upon installation, the modified OEM smoke alarm may be configured to notify one or more entities, sound an audible alarm, or take other actions upon determining that the smoke alarm has been tampered with.

In other cases, interpreting sensor data by the controller or processor may include detecting at least a specified minimum amount of change in a monitored characteristic. In LED/photodiode scenarios, for example, the specified minimum amount of change may be measured and specified in the number of lumens emitted by the LED. Once that minimum number of lumens is no longer being received at the photodiode, the processor may trigger an audible warning or may generate and send a notification.

In some examples, when the processor detects at least a specified minimum amount of change in a given monitored characteristic, this process of detection may include detecting a different amount of change in the monitored characteristic for each of a plurality of different sensor types. Thus, in such cases, the smoke alarm may include multiple transmitting sensor elements such as LEDs, magnets, IR emitters, etc., and the tamper detection device may include multiple receiving sensor elements. In one embodiment, for instance, a smoke alarm may include both an LED emitter and a magnet, while the tamper detection device may include a photodiode to detect the LED's emissions and a magnetometer to detect the magnet's magnetic field. Higher numbers of sensors or different types of sensors may be used. In the example above, both a minimum amount of change in lumens from the LED emitter and a minimum change in magnetic field strength are to be detected by the processor before signaling an alarm or notifying specified entities. Thus, multiple sensors and multiple corresponding and different thresholds may be involved before triggering an alarm.

In other cases, detecting at least a specified minimum amount of change in the monitored characteristic may include detecting a different amount of change in the monitored characteristic for each of multiple different locations in which the apparatus is mounted. For instance, at least in some embodiments, if the smoke alarm is installed in a location that receives little ambient light, the thresholds for reaching the specified minimum amount of change may be lowered. On the other hand, if the smoke alarm is mounted in a location that receives direct sunlight or large amounts of ambient light, the thresholds may be higher. Other sensor thresholds may be similarly adjusted based on the environment in which the smoke alarm is installed.

In still other cases, detecting a specified minimum amount of change in the monitored characteristic may include detecting a different amount of change in the monitored characteristic for each of multiple different users that implement the apparatus. Some users may be more likely to try to tamper with their smoke alarm than other users. Users that have tried, in the past, to tamper with their smoke alarm may be flagged and their location may be noted. Tamper detection devices installed in that location (e.g., according to GPS coordinates) may have lower thresholds in the amount of change because a change is more likely there. Conversely, users that rarely or never tamper with their smoke alarm may have standard thresholds for their tamper detection devices. Accordingly, users and locations known to perform such tampering may have lower thresholds that lead to quicker triggers and earlier notifications in order to avoid situations where a smoke alarm has been covered, disconnected, or otherwise disabled.

In addition to the system described above, an apparatus may be provided that includes: a tamper detection component that is affixed to at least a portion of a smoke alarm, a support structure that includes a locking mechanism and an extended portion that aligns with an extended cavity of an interlocking cover portion, a sensor positioned within a specified maximum distance from the tamper detection component, an interlocking cover portion that includes an aperture for the sensor and that locks into place over the support structure using the locking mechanism, a controller configured to interpret sensor data received from the sensor, and a transmitter configured to transmit notification data to one or more specified entities based on the interpreted sensor data.

A corresponding tamper detection device may also be provided, which may include: a tamper detection component that is affixed to at least a portion of a smoke alarm, a support structure that includes a locking mechanism and an extended portion that aligns with an extended cavity of an interlocking cover portion, a sensor positioned within a specified maximum distance from the tamper detection component, the interlocking cover portion that includes an aperture for the sensor and that locks into place over the support structure using the locking mechanism, a controller configured to interpret sensor data received from the sensor, and a transmitter configured to transmit notification data to one or more specified entities based on the interpreted sensor data.

Embodiments described herein may implement various types of processors, controllers, or other types of computing systems that may be used in any of the embodiments described herein. In this description and in the claims, the term “computing system” is defined broadly as including any device or system (or combination thereof) that includes at least one physical and tangible processor, and a physical and tangible memory capable of having thereon computer-executable instructions that may be executed by the processor. A computing system may be distributed over a network environment and may include multiple constituent computing systems.

Computing systems typically include at least one processing unit and memory. The memory may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “executable module” or “executable component” can refer to software objects, routines, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory of the computing system. Computing system may also contain communication channels that allow the computing system to communicate with other message processors over a wired or wireless network.

Embodiments described herein may comprise or utilize a special-purpose or general-purpose computer system that includes computer hardware, such as, for example, one or more processors and system memory, as discussed in greater detail below. The system memory may be included within the overall memory. The system memory may also be referred to as “main memory,” and includes memory locations that are addressable by the processing unit over a memory bus in which case the address location is asserted on the memory bus itself. System memory has been traditionally volatile, but the principles described herein also apply in circumstances in which the system memory is partially, or even fully, non-volatile.

Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

In some cases, the computer system may include a communications module that communicates with other computing systems. The communications module may include any wired or wireless communication means that can receive and/or transmit data to or from other computing systems. The communications module may be configured to interact with databases, mobile computing devices (such as mobile phones or tablets), embedded or other types of computing systems.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. A system, comprising:
a tamper detection component that is affixed to at least a portion of a smoke alarm;
a support structure that includes a locking mechanism and an extended portion that aligns with an extended cavity of an interlocking cover portion;
a sensor positioned within a specified maximum distance from the tamper detection component;
the interlocking cover portion that includes an aperture for the sensor and that locks into place over the support structure using the locking mechanism;
a controller configured to interpret sensor data received from the sensor; and
a transmitter configured to transmit notification data to one or more specified entities based on the interpreted sensor data.

2. The system of claim 1, wherein the locking mechanism comprises a geared locking mechanism.

3. The system of claim 1, wherein the tamper detection component comprises a magnet.

4. The system of claim 3, wherein the sensor comprises a magnetometer configured to detect at least one of a magnetic field's direction, strength, or relative change.

5. The system of claim 1, wherein the support structure is secured to a wall or ceiling and is positioned substantially adjacent to the smoke alarm.

6. The system of claim 1, wherein the interlocking cover portion is secured in place over the support structure via at least one of a magnet, a threaded connection, a screw, a clasp, or a securing pin.

7. The system of claim 1, wherein the sensor comprises at least one of a microwave motion detector, a passive infrared (PIR) sensor, or a photodiode configured to sense light from a light emitting diode.

8. The system of claim 1, wherein the tamper component is affixed to an exterior portion of the smoke alarm.

9. The system of claim 1, wherein the tamper component is affixed to an interior portion of the smoke alarm.

10. The system of claim 9, wherein the sensor is mounted internally within the smoke alarm and is positioned within the specified maximum distance from the tamper detection component.

11. The system of claim 1, wherein the interlocking cover portion includes one or more molded indicators indicating how to align the sensor with the tamper detection component.

12. An apparatus, comprising:
a tamper detection component that is affixed to at least a portion of a smoke alarm;
a support structure that includes a locking mechanism and an extended portion that aligns with an extended cavity of an interlocking cover portion;
a sensor positioned within a specified maximum distance from the tamper detection component;
the interlocking cover portion that includes an aperture for the sensor and that locks into place over the support structure using the locking mechanism;
a controller configured to interpret sensor data received from the sensor; and
a transmitter configured to transmit notification data to one or more specified entities based on the interpreted sensor data.

13. The apparatus of claim 12, wherein interpreting sensor data by the controller includes detecting at least a specified minimum amount of change in a monitored characteristic.

14. The apparatus of claim 13, wherein detecting at least a specified minimum amount of change in the monitored characteristic includes detecting a different amount of change in the monitored characteristic for each of a plurality of different sensor types.

15. The apparatus of claim 13, wherein detecting at least a specified minimum amount of change in the monitored characteristic includes detecting a different amount of change in the monitored characteristic for each of a plurality of different locations in which the apparatus is mounted.

16. The apparatus of claim 13, wherein detecting at least a specified minimum amount of change in the monitored characteristic includes detecting a different amount of change in the monitored characteristic for each of a plurality of different users that implement the apparatus.

17. The apparatus of claim 12, wherein the tamper component is affixed to an interior portion of the smoke alarm.

18. The apparatus of claim 17, wherein the sensor is mounted internally within the smoke alarm and is positioned within the specified maximum distance from the tamper detection component.

19. The apparatus of claim 12, wherein the tamper detection component comprises a magnet, and wherein the sensor comprises a magnetometer configured to detect at least one of a magnetic field's direction, strength, or relative change.

20. A tamper detection device, comprising:
a tamper detection component that is affixed to at least a portion of a smoke alarm;
a support structure that includes a locking mechanism and an extended portion that aligns with an extended cavity of an interlocking cover portion;
a sensor positioned within a specified maximum distance from the tamper detection component;
the interlocking cover portion that includes an aperture for the sensor and that locks into place over the support structure using the locking mechanism;
a controller configured to interpret sensor data received from the sensor; and
a transmitter configured to transmit notification data to one or more specified entities based on the interpreted sensor data.
